(19) United States
(12) Patent Application Publication
(10) Pub. No.: US 2024/0067017 A1
(43) Pub. Date: Feb. 29, 2024

(54) SYSTEMS AND METHODS FOR ELECTRIC VEHICLE CHARGING USING AUTONOMOUS CHARGING ROBOTS

(71) Applicant: The Energy Company, LLC, San Diego, CA (US)

(72) Inventor: Ahmed Owiess, San Diego, CA (US)

(21) Appl. No.: 18/239,023

(22) Filed: Aug. 28, 2023

Related U.S. Application Data
(60) Provisional application No. 63/402,025, filed on Aug. 29, 2022.

(51) Int. Cl. B60L 53/35; B60L 53/30; B60L 53/31; B60L 53/67; G05D 1/00; G05D 1/02

(52) U.S. Cl. CPC B60L 53/35; B60L 53/305; B60L 53/31; B60L 53/67; G05D 1/0088; G05D 1/0289

(57) ABSTRACT

A method for charging electric vehicle batteries using autonomous charging robots including an energy storage system therein may include obtaining a request to charge an electric vehicle battery connected to a charging pillar, determine, in response to the request, a mapping including a routing path for an autonomous charging robot to navigate between a charging hub at a first location and the charging pillar at a second location, and send the mapping to the autonomous charging robot to trigger navigating and connecting to the charging pillar to fulfill the request and charge the electric vehicle battery. The autonomous charging robot may be configured to electrically connect with the charging pillar to charge the electric vehicle battery. The computing device may be in electronically communicable connection with one or more autonomous charging robots to coordinate deployment of the autonomous charging robots to fulfill the request.

### CROSS-REFERENCE TO RELATED APPLICATIONS

The present application claims priority to and benefit of U.S. Provisional Patent Application No. 63/402,025, filed Aug. 29, 2023, and entitled “SYSTEM AND APPARATUS FOR AUTOMATED CHARGING OF ELECTRIC VEHICLES,” the entirety of which is herein incorporated by reference.

### FIELD

The present disclosure relates to the field of electric vehicle charging. And, more particularly, to systems for automated charging of electric vehicles using moving robots that are not directly connected to a power grid while charging electric vehicles.

### BACKGROUND

With increased adoption of electric vehicles (EVs), the need for support infrastructure for such vehicles has increased with industry demand. In particular, charging facilities have been deployed to many locations such as, for example, shopping centers, shopping malls, movie theaters, airports, and stadiums, to support EV charging at these locations. Customers with EVs can visit these locations and can simultaneously charge their EV. Charging facilities are integrated into these various locations by installing charging points in certain parking spaces, with each charging point typically being connected to an electrical power source such as, for example, a utility power grid. Moreover, as the total number of charging points in the charging facility may be limited, the parking spaces having charging points are typically specifically designated for EVs.

### SUMMARY

Existing conventional charging facilities must typically be connected to a power grid. Accordingly, the location of charging facilities and the EV charging points within the charging facility are often limited to locations such as, for example, near buildings or on edges of parking areas where the charging points can be connected to the power grid while minimizing the impact on other areas during both installation and operation. The costs associated with connecting each EV charging point in a charging facility to the power grid can limit the number of charging points a charging facility may provide. Furthermore, placing a charging point at a location often involves converting a parking space to a designated charging point, thereby reducing the number of parking spaces available for customers that do not require EV charging services.

When charging their EV at the charging facility, customers leave their EV parked in one of a limited number of available spaces having a charging point and charge their EV with the charging point. However, customers may leave their EV in one of the limited available spaces for a time period beyond the charging cycle of the EV while visiting other attractions at or near the location of the charging facility. For example, the charging facility may be located in a parking lot of a restaurant where the time period for the customer to dine at the restaurant exceeds the charge cycle of the EV. This creates inefficiencies such as a reduction in available charging points for other EVs in need of charging and loss of potential revenue. Thus, there is an unmet need for charging systems that can allow charging capabilities to be provided to parked EV vehicles when needed, but which still provide regular parking locations when charging is not needed.

Example implementations of the present application may meet these unmet needs, though solving these unmet needs is not a requirement of the present application.

In some embodiments, a system for charging an electric vehicle including one or more autonomous charging robots, the system includes a computing device including a processor, and a non-transitory computer readable medium having stored thereon instructions that are executable by the processor to enable the system to perform operations including obtain a request to charge an electric vehicle battery connected to a charging pillar from a second computing device, determine, in response to the request, a mapping including a routing path for an autonomous charging robot of the one or more autonomous charging robots to navigate between a charging hub at a first location and the charging pillar at a second location, and send the mapping to the autonomous charging robot to trigger the autonomous charging robot to navigate and connect to the charging pillar to fulfill the request, the autonomous charging robot is configured to electrically connect with the charging pillar to charge the electric vehicle battery, and the computing device is in electronically communicable connection with the autonomous charging robot to coordinate deployment of the autonomous charging robot to fulfill the request.

In some embodiments, the mapping further includes an area including the charging hub at the first location and the charging pillar at the second location.

In some embodiments, the system further performs operations including determine routing paths of other autonomous charging robots and predict a position of the other autonomous charging robots during navigation of the autonomous charging robot to the charging pillar, the routing path of the autonomous charging robot between the charging hub and the charging pillar is determined based on routing paths of the other autonomous charging robots and their predicted positions.

In some embodiments, the system further performs operations including obtain one or more parameters from one or more sensors on the autonomous charging robot during fulfillment of the request, and determine, in response to the autonomous charging robot detecting an interference in the routing path, a second routing path between the charging hub and the charging pillar navigating the autonomous charging robot around the interference, the second routing path including a new route between the charging hub and the charging pillar based on a current location and position of the autonomous charging robot in the mapping.

In some embodiments, the one or more sensors is selected from a group including light detection and ranging sensors, cameras, gyroscopes, global positioning system (GPS), battery charge level detectors, and current and voltage detectors.

In some embodiments, the system further includes a plurality of charging hubs at the first location, and a plurality of charging pillars at the second location, and the mapping navigates the autonomous charging robot to the charging pillar of the plurality of charging pillars, each charging location in a charging facility includes one of the plurality of charging pillars.

In some embodiments, the one or more autonomous charging robots includes a first autonomous charging robot and a second autonomous charging robot.

In some embodiments, the system further performs operations including determine the request to charge the electric vehicle battery exceeds a capacity of the first autonomous charging robot, identify the second autonomous charging robot to charge the electric vehicle battery, determine a second mapping including a second routing path for the second autonomous charging robot to move between the charging hub and the charging pillar to fulfill the request, and send the second mapping to the second autonomous charging robot to trigger the second autonomous charging robot to navigate and connect to the charging pillar to fulfill the request to charge the electric vehicle battery.

In some embodiments, the mapping to the first autonomous charging robot corresponds to a first charge period and the second mapping to the second autonomous charging robot corresponds to a second charge period, the second charge period occurs after the first charge period and fulfilling the request includes the first charge period and the second charge period.

In some embodiments, the charging pillar includes a first connection interface on a first side of the charging pillar, and a second connection interface on a second side of the charging pillar, the first autonomous charging robot connects to the first connection interface or the second connection interface and the second autonomous charging robot connects to the other of the first connection interface and the second connection interface.

In some embodiments, the system further performs operations including determine the electric vehicle is electrically connected to the charging pillar, determine the autonomous charging robot is electrically connected to the charging pillar, and control the charging pillar to enable a battery of the autonomous charging robot to charge the electric vehicle battery.

In some embodiments, a computer-implemented method includes determining an electric vehicle is electrically connected to a charging pillar, determining, by a computing device and in response to a request to charge an electric vehicle battery connected to the charging pillar, a mapping including an area of a charging hub and the charging pillar and including a routing path for an autonomous charging robot to navigate between the charging hub at a first location and the charging pillar at a second location, determining, by the computing device, routing paths of other autonomous charging robots and predict a position of the other autonomous charging robots during navigation of the autonomous charging robot to the charging pillar, sending, by the computing device, the mapping to the autonomous charging robot to trigger the autonomous charging robot to navigate and connect to the charging pillar to fulfill the request, obtaining, by the computing device, one or more parameters from one or more sensors on the autonomous charging robot during fulfillment of the request, control the charging pillar to enable a battery of the autonomous charging robot to charge the electric vehicle battery, and the autonomous charging robot is configured to electrically connect with the charging pillar to charge the electric vehicle battery, and the computing device is in electronically communicable connection with the autonomous charging robot to coordinate deployment of the autonomous charging robot to fulfill requests to charge electric vehicle batteries.

In some embodiments, the computer-implemented method further includes obtaining one or more parameters from one or more sensors on the autonomous charging robot during fulfillment of the request, and determining, in response to the autonomous charging robot detecting an interference in the routing path, a second routing path between the charging hub and the charging pillar navigating the autonomous charging robot around the interference, the second routing path includes a new route between the charging hub and the charging pillar based on a current location and position of the autonomous charging robot in the mapping.

In some embodiments, the autonomous charging robot includes a first autonomous charging robot and a second autonomous charging robot.

In some embodiments, the computer-implemented method further includes determining the request to charge the electric vehicle battery exceeds a capacity of the first autonomous charging robot, identifying the second autonomous charging robot to charge the electric vehicle battery, determining a second mapping including a second routing path for the second autonomous charging robot to move between the charging hub and the charging pillar to fulfill the request, sending the second mapping to the second autonomous charging robot to trigger the second autonomous charging robot to navigate and connect to the charging pillar to fulfill the request, the mapping to the first autonomous charging robot corresponds to a first charge period and the second mapping to the second autonomous charging robot corresponds to a second charge period, and the second charge period occurs after the first charge period and fulfilling the request includes the first charge period and the second charge period.

In some embodiments, the charging pillar includes a first connection interface on a first side of the charging pillar, and a second connection interface on a second side of the charging pillar, the first autonomous charging robot connects to the first connection interface or the second connection interface and the second autonomous charging robot connects to the other of the first connection interface and the second connection interface.

In some embodiments, a computer program product includes instructions stored on a non-transitory computer readable medium of a computing device, the instructions being executable by a processor to enable the computing device to perform operations including determine an electric vehicle is electrically connected to a charging pillar, determine, in response to a request to charge an electric vehicle battery connected to the charging pillar, a mapping including an area of a charging hub and the charging pillar and including a routing path for an autonomous charging robot to navigate between the charging hub at a first location and the charging pillar at a second location of a charging facility, determine routing paths of other autonomous charging robots and predict a position of the other autonomous charging robots in the charging facility during navigation of the autonomous charging robot to the charging pillar, send the mapping to the autonomous charging robot to trigger the autonomous charging robot to navigate and connect to the charging pillar to fulfill the request, obtain one or more parameters from one or more sensors on the autonomous charging robot during fulfillment of the request, control the charging pillar to enable a battery of the autonomous charging robot to charge the electric vehicle battery, and the autonomous charging robot is configured to electrically connect with the charging pillar to charge the electric vehicle battery, and the computing device is in electronically communicable connection with the autonomous charging robot to coordinate deployment of the autonomous charging robot to fulfill the request.

In some embodiments, the computer program product enables the processor to further perform operations including obtain one or more parameters from one or more sensors on the autonomous charging robot during fulfillment of the request, and determine, in response to the autonomous charging robot detecting an interference in the routing path, a second routing path between the charging hub and the charging pillar navigating the autonomous charging robot around the interference, the second routing path including a new route between the charging hub and the charging pillar based on a current location and position of the autonomous charging robot in the mapping.

In some embodiments, the computer program product enables the processor to further perform operations including determine the request to charge the electric vehicle battery exceeds a capacity of the autonomous charging robot, identify a second autonomous charging robot to charge the electric vehicle battery, determine a second mapping including a second routing path for the second autonomous charging robot to move between the charging hub and the charging pillar to fulfill the request, send the second mapping to the second autonomous charging robot to trigger the second autonomous charging robot to navigate and connect to the charging pillar to fulfill the request, the mapping to the autonomous charging robot corresponds to a first charge period and the second mapping to the second autonomous charging robot corresponds to a second charge period, and the second charge period occurs after the first charge period and fulfilling the request includes the first charge period and the second charge period.

In some embodiments, the charging pillar includes a first connection interface on a first side of the charging pillar, and a second connection interface on a second side of the charging pillar, the autonomous charging robot connects to the first connection interface or the second connection interface and the second autonomous charging robot connects to the other of the first connection interface and the second connection interface to simultaneously charge the electric vehicle battery.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 illustrates a block diagram of a non-limiting example embodiment of a system, according to some embodiments.

FIG. 2 illustrates a block diagram of a non-limiting example computing environment of the system, according to some embodiments.

FIG. 3 is a perspective view illustrating a portion of the system, according to some embodiments.

FIG. 4 is a perspective view illustrating a portion of the system, according to some embodiments.

FIG. 5a is a perspective view illustrating a portion of the system 100, according to some embodiments.

FIG. 5b is a perspective view illustrating a portion of the system, according to some embodiments.

FIG. 6 is a block diagram illustrating a non-limiting example of a system, according to some embodiments.

FIG. 7 is a perspective view of the system, according to some embodiments.

FIG. 8 is a perspective view illustrating a portion of system, according to some embodiments.

FIG. 9 is a perspective view illustrating a non-limiting example of system, according to some embodiments.

FIG. 10 is graphical illustrations of a portion of system, according to some embodiments.

FIG. 11 is a perspective view illustrating a non-limiting example of a portion of system, according to some embodiments.

FIG. 12 is a graphical illustration of the portion of system, according to some embodiments.

FIG. 13 is a flow diagram illustrating a method, according to some embodiment.

FIG. 14 is a flow diagram illustrating a method, according to some embodiment.

FIG. 15 is a flow diagram illustrating a method, according to some embodiment.

### DETAILED DESCRIPTION

Various embodiments of the present disclosure may relate to systems including a charging pillar, a charging hub, and one or more autonomous charging robots (ROS). Various embodiments of the present disclosure may also relate to systems, computer-implemented methods, and computer program products to control an operation of the charging pillars, charging hubs, and ROS. The system may include a robot management system (e.g., controller), which may be in electrically communicable connection with one or more of the charging hubs, charging pillar, and the autonomous charging robots to send and receive data including instructions for charging an electric vehicle battery in response to a charge request. The ROS includes a high capacity energy storage system for storing electrical power. The ROS is configured to electrically connect to a charging hub at a first location to receive energy from the charging hub, store the energy in the onboard high capacity energy storage system, autonomously navigate to a charging pillar at a second location remote from the first location to deliver the charged energy storage system, electrically connect to the charging pillar and provide the stored energy from the high capacity energy storage system to the charging pillar, the charging pillar being configured to dispense the energy to the energy storage system of an electric vehicle (“EV”).

The system may include a plurality of charging hubs at the first location, according to some embodiments. In some embodiments, each charging hub may electrically connect to more than one ROS at one time and charge all the ROS connected thereto simultaneously. Additionally, the system may include a plurality of charging pillars at the second location, according to some embodiments. In some embodiments, the charging pillar may electrically connect to more than one ROS at one time such that the more than one ROS may simultaneously charge the EV battery.

The various embodiments herein can improve the charging of electric vehicles by providing systems that may be installed into locations such as, for example, in parking lots having a limited number of total available spaces. Each parking space in the parking lot can have a charging pillar installed at each space at a reduced cost compared to installing traditional charging stations connected to the utility power grid or other power generator source at each space. Instead, the autonomous charging robots can charge their high capacity energy storage system at the charging hub at the first location and can deliver the electrical energy to the second location of the charging pillar to charge the EV battery, while also navigating around any obstacles that may be detected between the charging hub and the charging pillar. Accordingly, each parking space in the parking lot can be used by either gasoline powered vehicles or EVs without having to designate certain spaces specifically for EV charging. This provides EVs with more parking options with the capability to charge their EV in parking lots that may have a limited number of available spaces and also avoids having to reduce the total number of available spaces for other types of vehicles.

The systems can also reduce costs associated with installing EV charging facilities into locations as the charging pillars are not tied to a utility power grid or other power source. Instead, the charging hub at the first location is connected to the grid power source or other power generator source and the autonomous charging robots can move between the charging hub at the first location and the charging pillars at the second location. This reduces the amount of construction that may be needed to connect the charging hubs to the power source compared to conventional charging stations as the charging hubs are confined to the first location whereas each charging station is tied to the grid power source. This allows charging facilities to be installed into a variety of different locations which previously may not have been well-suited for installing conventional charging stations.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

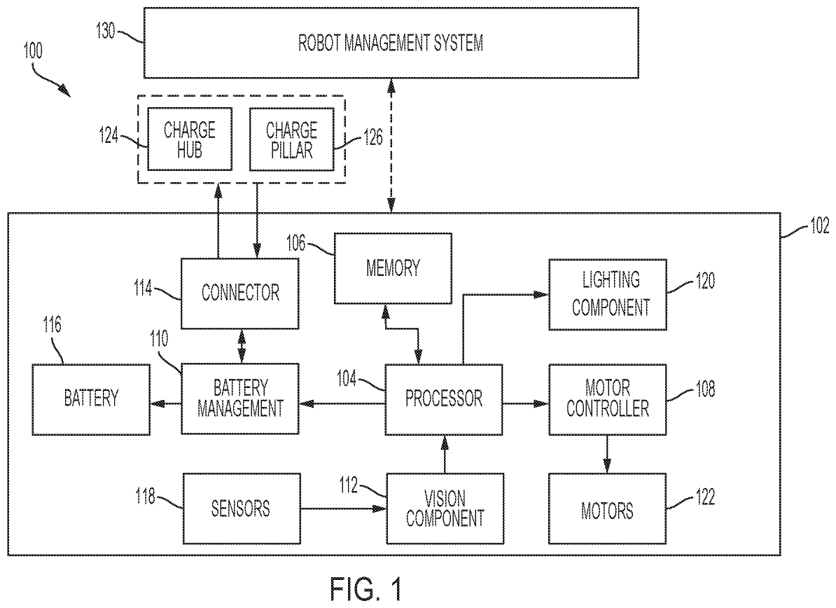

FIG. 1 is a block diagram illustrating a non-limiting example of a system 100, according to some embodiments.

System 100 includes an autonomous charging robot 102, a charge hub 124, and a charging pillar 126. The robot 102, which may also be referred to as robot operating system (ROS) 102, includes one or more modules and/or components to enable the ROS 102 to deliver a high capacity energy storage system (e.g., batteries) between the charge hub 124 to charge the energy storage system and the charging pillar 126 to discharge the energy storage system to an external energy storage system such as, for example, an EV battery. The charge hub 124 is installed at a first location and is electrically connected to a grid tied power source or other power generator source. The ROS 102 electrical connects to the charge hub 124 to charge the high capacity energy storage system with the power source connected to the charge hub 124. The charging pillar 126 is installed at a second location and may be electrically connected to EVs for charging EV batteries. The ROS 102 electrically connects to the charging pillar 126 and the charging pillar 126 transfers the electrical power stored in the battery 116 to the EV to charge the EV battery. In some embodiments, the second location may be remote from the first location. For example, the charge hub 124 may be installed at an edge of a parking lot and the charging pillar 126 may be located at one or more of the parking spaces of the parking lot.

The system 100 may include a robot management system 130, according to some embodiments. The ROS 102 may be in electrically communicable connection with the robot management system 130 that directs deployment of one or more autonomous charging robots such as, for example, ROS 102 between one or more charging hubs, also referred to as hub posts, connected to a power grid or power generator and one or more charging posts configured to connect to EVs.

As illustrated, the ROS 102 communicates with the robot management system 130 via a network connection. In many embodiments, the ROS 102 may communicate using a wireless communication system (e.g., Cellular connection, Wireless Local Area Network (WI-LAN), Bluetooth, or any other wireless communication protocol that might be apparent to a person of ordinary skill in the art). However, example embodiments are not limited to this configuration and may communicate with the robot management system using a wired connection or any other connection that might be apparent to a person of ordinary skill in the art.

The ROS 102 includes a processor 104, a memory 106, a motor controller 108, a battery management component 110, a vision component 112, and a connector 114. The processor 104 provides one or more control functionalities including battery management, 360° vision processing through vision component 112, lighting control component 120 to improve visibility, and motor control. In some embodiments, the ROS 102 may include one or more processors, such as processor 104 for performing the one or more control functionalities as described herein. The memory 106 may include a non-transitory computer readable medium having stored thereon instructions that are executable by the processor to perform operations including the one or more control functionalities. The instructions stored in the processor 104 may be executed by the processor to control the operation of the one or more other modules of the ROS 102, as will be further described herein. In some embodiments, the ROS 102 may include a computing device including the processor 104 and memory 106 and robot management system 130. The computing device may include other components from the one or more other modules such as, for example, the motor controller 108.

The ROS 102 includes the motor controller 108. The motor controller 108 may be configured to control operation of one or more motors 122 coupled to locomotion systems to move the ROS 102. In this regard, in some embodiments, the motor controller 108 may further include a processor and a memory having stored thereon instructions that are executable by the processor to perform operations including controlling the operation of the one or more motors to move the ROS 102, as will be further described herein.

The ROS 102 includes the battery management component 110. The ROS 102 also includes a battery 116, the battery management component 110 being configured to control the charge/discharge operations of the battery 116. The battery 116 may be a high capacity energy storage device including therein one or more battery packs coupled together, according to some embodiments. Each battery pack may include therein one or more battery cells coupled together. The number of battery cells in each battery pack and the number of battery packs in the battery 116 and included in the ROS 102 may be configured depending on the charging requirements of a particular charging facility.

The ROS 102 may include the vision component 112. The vision component 112 may include a 360° machine vision system configured to detect and/or identify objects in a vicinity of the ROS 102 based on inputs from one or more sensors 118. The vision component 112 may obtain the input data from the one or more sensors 118 and may apply one or more models and/or techniques to the input data such as, for example, computer vision models to identify different objects in the images. This enable the ROS 102 to map a course to navigate between the charging hub and the charging post to perform the charging operations as described herein, to determine the mapped course is impeded by an object, map a detour between its present location and the charging hub or the charging post, and to identify a location of a complementary connection interface on the charging hub or the charging pillar to enable a docking port 168 located on the exterior of ROS 102 to connect the charging hub 124 or charging pillar 126. In some embodiments, the one or more sensors 118 may emit light pulses and detect objects in an area surrounding the ROS 102 based on the emitted light pulses that are detected as being reflected back to the one or more sensors 118. In other embodiments, the one or more sensors 118 may include one or more cameras configured to capture one or more images of scenes which when compiled show a scene of the 360° area surrounding the ROS 102. It is to be appreciated by those having ordinary skill in the art that the one or more sensors 118 of the ROS 102 are not intended to be limiting and may include any of a plurality of different types of sensors capable of monitoring various different parameters including, but not limited to, location, position, orientation, object proximity, collision detection, noise, temperature, humidity, battery charge level, voltage, current, other parameters, or any combinations thereof.

The ROS 102 includes the connector 114. The connector 114 enables the ROS 102 to selectively couple to either a charging post or a hub post to send or receive energy. The connector 114 includes therein one or more components capable of a mating physical engagement to a connection interface at the charging post or the hub post having therein one or more complementary components configured to enable the connector 114 to connect to the charging post or the hub post.

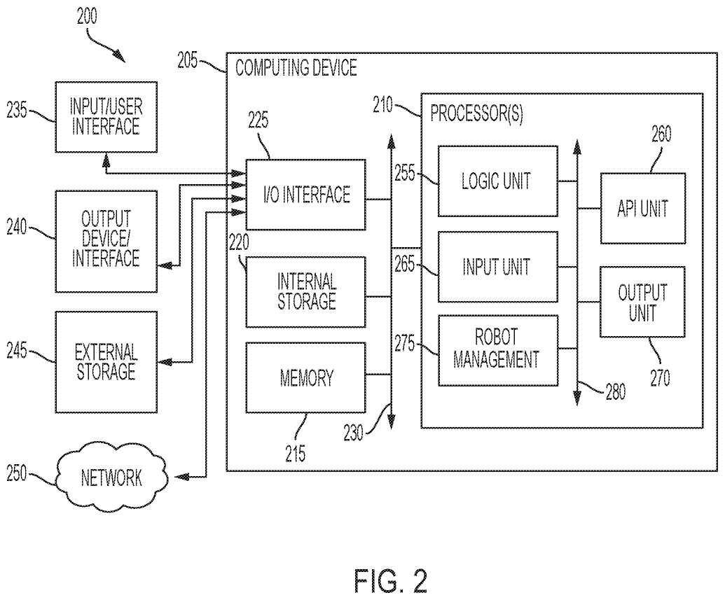

FIG. 2 illustrates a block diagram of a non-limiting example computing environment 200 of the system 100, according to some embodiments.

One or both of the robot management system 130 and the ROS 102 may be considered a computing device having any of the components shown in FIG. 2, according to some embodiments. Computing device 205 in computing environment 200 can include one or more processing units, cores, or processors 210, memory 215 (e.g., RAM, ROM, and/or the like), internal storage 220 (e.g., magnetic, optical, solid state storage, and/or organic), and/or I/O interface 225, any of which can be coupled on a communication mechanism or bus 230 for communicating information or embedded in the computing device 205. Computing device 205 can be communicatively coupled to input/interface 235 and output device/interface 240. Either one or both of input/interface 235 and output device/interface 240 can be a wired or wireless interface and can be detachable. Input/interface 235 may include any device, component, sensor, or interface, physical or virtual, which can be used to provide input (e.g., buttons, touch-screen interface, keyboard, a pointing/cursor control, microphone, camera, braille, motion sensor, optical reader, and/or the like).

Output device/interface 240 may include a display, television, monitor, printer, speaker, braille, or the like. In some embodiments, input/interface 235 (e.g., user interface) and output device/interface 240 can be embedded with, or physically coupled to, the computing device 205. In other embodiments, other computing devices may function as, or provide the functions of, an input/interface 235 and output device/interface 240 for a computing device 205. These elements may include, but are not limited to, well-known AR hardware inputs so as to permit a user to interact with an AR environment.

Computing device 205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 205 can be communicatively coupled (e.g., via I/O interface 225) to external storage 245 and network 250 for communicating with any number of networked components, devices, and systems, including one or more computing devices of the same or different configuration. Computing device 205 or any connected computing device can be functioning as, providing services of, or referred to as a server, client, thin server, general machine, special-purpose machine, or another label.

I/O interface 225 can include, but is not limited to, wired and/or wireless interfaces using any communication or I/O protocols or standards (e.g., Ethernet, 802.1 lxs, Universal System Bus, WiMAX, modem, a cellular network protocol, and the like) for communicating information to and/or from at least all the connected components, devices, and network in computing environment 200. Network 250 can be any network or combination of networks (e.g., the Internet, local area network, wide area network, a telephonic network, a cellular network, satellite network, and the like).

Computing device 205 can use and/or communicate using computer-usable or computer-readable media, including transitory media and non-transitory media. Transitory media includes transmission media (e.g., metal cables, fiber optics), signals, carrier waves, and the like. Non-transitory media includes magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 210 can execute under any operating system (OS) (not shown), in a native or virtual environment. One or more applications can be deployed that include logic unit 255, application programming interface (API) unit 260, input unit 265, output unit 270, robot management unit 275, and inter-unit communication mechanism 280 (e.g., a data bus) for the different units to communicate with each other, with the OS, and with other applications (not shown). For example, output unit 270, robot management unit 275, and inter-unit communication mechanism 280 may implement one or more processes to communicate and control the robots of the system. The described units and elements can be varied in design, function, configuration, or implementation and are not limited to the descriptions provided.

In some embodiments, when information or an execution instruction is received by API unit 260, it may be communicated to one or more other units (e.g., robot management unit 275). For example, the robot management unit 275 may determine how the robot should be controlled and communicate the instructions through the output unit 270. In some instances, the logic unit 255 may be configured to control the information flow among the units and direct the services provided by API unit 260, robot management unit 275, and inter-unit communication mechanism 280 in some example embodiments as described above. For example, the flow of one or more processes or implementations may be controlled by logic unit 255 alone or in conjunction with API unit 260.

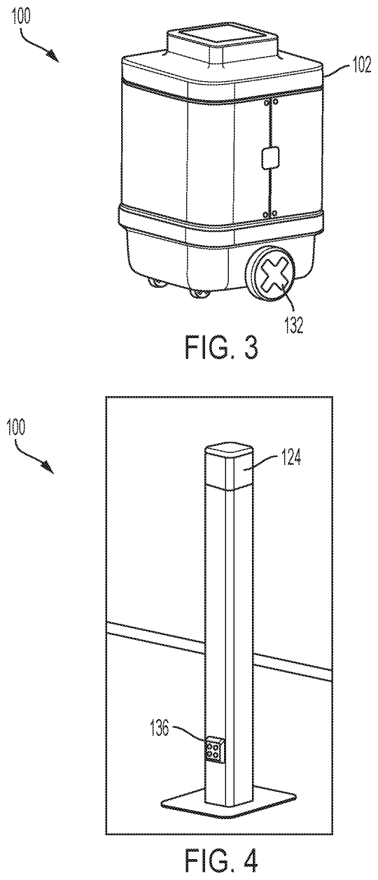

FIG. 3 is a perspective view illustrating a portion of the system 100, according to some embodiments.

The system 100 includes the ROS 102. The ROS 102 is in electrically communicable connection with the robot management system 130 and can send and receive data with the robot management system 130 to fulfill requests to charge the EV battery. For example, ROS 102 can obtain data from the robot management system 130 to charge an EV battery connected to a particular charging pillar 126 in the charging facility including a mapping for the ROS 102 to navigate from the current location of the ROS 102 (e.g., charge hub 124) to the charging pillar 126. In some embodiments, the ROS 102 may be a first computing device and the robot management system 130 may be a second computing device. In other embodiments, the computing device of the ROS 102 may also include the robot management system 130.

The ROS 102 includes therein a battery module having the battery 116 serving as the high capacity energy storage system. The ROS 102 includes a docking port having a connector 114 for electrically connecting to the charge hub 124 and charging pillar 126. The ROS 102 electrically connects to the charge hub 124 to charge the battery 116 with electrical energy from the power source in connection with the 124, e.g., utility power grid or other power generator source. The ROS 102 stores the charge in the battery 116 and can autonomously move from the charge hub 124 to a charging pillar 126 in response to a request to charge the EV battery. To charge the EV battery, the ROS 102 electrically connects to the charging pillar 126, thereby placing the battery 116 in connection with the charge hub 124 through the docking port 168 and connector 114, to charge the EV battery.

The ROS 102 includes a drive module (not shown) to move the ROS 102 between the charge hub 124 at the first location and the charging pillar 126 at the second location to fulfill the charge requests to charge EV batteries. The ROS 102 includes one or more drive wheels 132 connected to one or more motors 134 which cause the one or more drive wheels 132 to move the ROS 102 forward and/or backward. In some embodiments, each drive wheel 132 may be connected to a motor 134 to enable independent control of each drive wheel 132. In this regard, the ROS 102 may move in forward and reverse directions and also turn about an axis of the ROS 102 within a certain radius (e.g., turning envelope).

FIG. 4 is a perspective view illustrating a portion of the system 100, according to some embodiments.

The system 100 includes the charge hub 124. The charge hub 124 is located at a first location of the charging facility. The charge hub 124 is electrically connected to the power grid, according to some embodiments. In other embodiments, the charge hub 124 is electrically connected to a power generator source. The charge hub 124 is installed at the first location of the charging facility and connected to the power source to provide the ROS 102 with a location for charging the battery 116 without having to install individual charging stations connected to the power source at each parking space in the charging facility.

The charge hub 124 includes a connection interface 136 located on a side of the charge hub 124 configured to electrically connect with the docking port 168 on the ROS 102 to charge the battery 116 on the ROS 102 with energy from the power source. Accordingly, the connection interface 136 is located on the side of the charge hub 124 at a position where the docking port 168 of the ROS 102 can connect to the charge hub 124 to charge the battery 116.

The charge hub 124 may have a construction similar to the charging pillar 126, but may be hardwired into a local power grid or otherwise physically connected to power generation facilities. For example, in some example embodiments, the charging hub pillar may be electrically connected to a solar array or other power generation system. In some embodiments, a solar array may be installed over a carport to provide power generation to the charge hub 124 without needing the charging hub pillar to be connected to a local power grid. The solar array on the carport is connected to its own battery storage which provides power directly to the charge hub 124. On opposite sides of the charge hub 124 is located the connection interface 136 so that the ROS 102 may be connected. In some embodiments, the charge hub 124 may include two of the connection interface 136 located on opposite sides of the charge hub 124 so that two of the ROS 102 may be charged simultaneously.

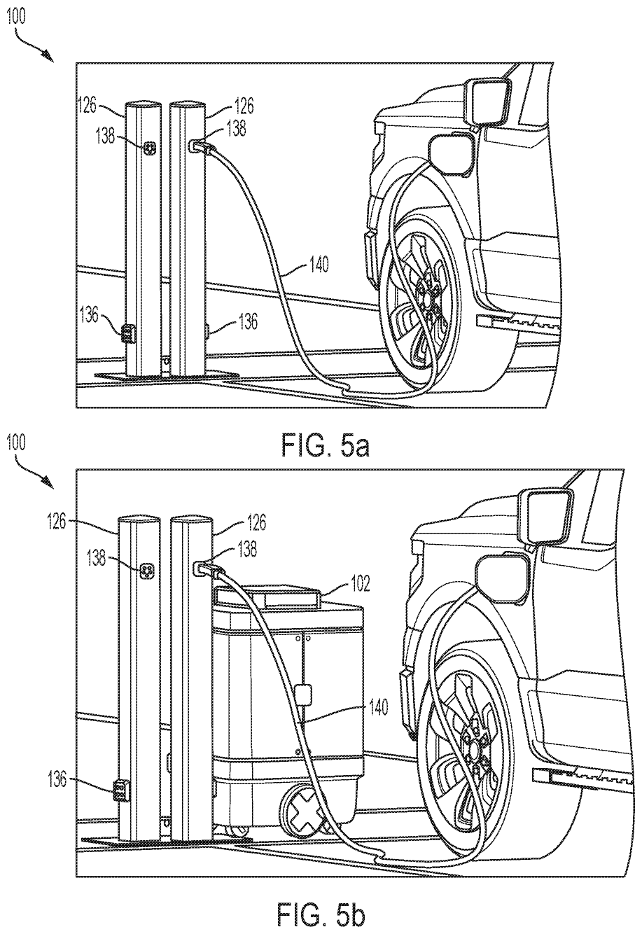

FIG. 5a is a perspective view illustrating a portion of the system 100, according to some embodiments. FIG. 5b is a perspective view illustrating a portion of the system 100, according to some embodiments. Unless specifically referenced, FIGS. 5a and 5b will be described collectively.

The system 100 includes the charging pillar 126. The charging pillar 126 is located at a second location of the charging facility remote from the first location. The charging pillar 126 is not electrically connected to the power grid. Instead, the ROS 102 is configured to deliver the charged battery 116 therein to the charging pillar 126 to charge the EV battery connected to the charging pillar 126. This enables the charging pillar 126 to be installed at the parking space (e.g., designated charge location) without having to run electrical power cables to connect to the charging pillar 126 to charge EV batteries. This simplifies the installation of charging points in the charging facility as the power source only needs to be installed and connected to the charge hub 124 at the first location rather than installing the electrical power cables to each charging pillar 126 in the charging facility.

Similar to the charge hub 124, the charging pillar 126 includes the connection interface 136 located on a side of the charging pillar 126 configured to electrically connect with the docking port 168 on the ROS 102 to charge an EV battery connected to the charging pillar 126 with the battery 116. Accordingly, the connection interface 136 is located on the side of the charging pillar 126 at a position where the docking port 168 of the ROS 102 can connect to the charge hub 124 to charge the battery 116.

According to some embodiments, the connector 114 and the docking port 168 on the ROS 102 can directly connect to the charging hub 124 to charge the battery 116 and the charging pillar 126 to charge the EV battery. In some embodiments, the ROS 102 and the connector 114 and the docking port 168 do not directly connect to the EV and/or the EV battery. Instead, to charge the EV battery, the ROS 102 connects to the charging pillar 126 and the charging pillar 126 connects to the EV to charge the EV battery with the electrical energy stored in the battery 116 through a charging cable connected to the receptacle 138.

Referring to FIG. 5a, charging pillar 126 includes a receptacle 138 located on a side of charging pillar 126 configured to connect to a first end of a charging cable 140. Additionally, the second end of the charging cable 140 may include a plug connector configured to connect to the EV to charge the EV battery. The plug connector on charging cable 140 may be specific to EVs from a certain manufacturer as different manufacturers may utilize different types of EV plug connectors having different configurations. Accordingly, the charging pillar 126 may be connected to a plurality of different charging cables 140, each charging cable 140 having a different plug connector on the second end, according to some embodiments. The charging cable includes, at the first end, a first electrical connector configured to connect to the charging pillar 126 and may include, at the second end, one of a plurality of different electrical plug connectors for electrically connecting to the EV.

A particular charging pillar 126 may charge multiple EVs through a time period (e.g., throughout the day), the multiple EVs using one or more different types of charging plug connectors. To enable the charging pillar 126 to charge each of the EVs, the charging pillar 126 may be interchangeably connected to different charging cables 140 having different plug connectors at the second end for each of the EVs at the second end. In some embodiments, the charging facility may include a location (e.g., storage cabinet), which is configured to store a plurality of different charging cables 140 that can be connected to the receptacle 138 of the charging pillar 126 and includes, at the second end, the correct plug connector for connecting to the EV to charge the battery.

The receptacle 138 on the charging pillar 126 may be a modular plug socket plug-in point that allows the charging pillar 126 to be customized to different EV charging standards that may be adopted in different regions or may be adopted by different EV manufacturers. Further, at a position lower on the charging pillar 126 compared to the receptacle 138, the connection interface 136 may be provided for the ROS 102 to connect to for power delivery. This is represented by a square connector illustrated with 4 circular contacts as shown in FIG. 5a. This is a representative configuration of the receptacle 138. However, it is to be appreciated by those having ordinary skill in the art that the receptacle 138 is not limited to this specific configuration and may include other types of connectors having other configurations in accordance with the present disclosure and as known to those having ordinary skill in the art.

Referring to FIG. 5b, ROS 102 connects to connection interface 136 located on the side of charging pillar 126 to charge the EV battery connected to receptacle 138. The connection interface 136 is located on a first side of the charging pillar 126 and the receptacle 138 is located on a second side of the charging pillar 126, according to some embodiments. In some embodiments, the first side is located adjacent the second side. In other embodiments, the first side is located opposite the second side. To request a charge for the EV battery, the EV battery may first be placed in electrical connection with the charging pillar 126 using the charging cable 140. The user associated with the EV may initiate the request by providing one or more inputs to a computing device corresponding to the charge request. The request is obtained by the system 100 and the robot management system 130 and the system 100 performs the operations as described herein to fulfill the charge request. In some embodiments, the charging pillar 126 may include the computing device, the computing device including a display and an interface that can receive inputs from the user for requesting the EV battery to be charged. In other embodiments, the computing device may be the user's computing device and the user may send the request to the system 100 and/or robot management system 130 through an application on the user's computing device. Once the system 100 obtains the charge request, the system 100 and/or robot management system 130 assigns and deploys ROS 102 to the charging pillar 126. The ROS 102 navigates from the charge hub 124 to the charging pillar 126 and electrically connects to the connection interface 136 of charging pillar 126. Once connected, the charging pillar 126 charges the EV battery with the electrical energy stored onboard battery 116.

As illustrated, the overall profile of the charging pillar 126 may be reduced as compared to existing EV charging stations since the charging pillar 126 is not required to be connected to a power grid or large power generating system. In other words, the infrastructure required to supply power existing EV charging station pillars may be omitted for the charging pillar 126 according to the example implementations of the present application. In order to comply with ADA accessibility recommendations, the EV charging plug-in point may be located between 42 inches (1070 mm) and 48 inches (1220 mm from the ground). This may set a minimum height of the EV charging pillar, but the height of the EV charging plug-in pillar may not need to be significantly taller than this minimum height.

In some embodiments, the operation of the charging pillar 126 may be done substantially remotely using a mobile device such as a phone, tablet, portable PC or other mobile device. For example, each EV charging pillar may be provided with a unique visual identifier code, such as a QR code or other bar code, or a unique non-visual identifier code, such as a near field communication (NFC) code. The customer may then capture the code using the mobile device and activate the charging pillar 126 using a mobile app installed on the mobile device or via a web browser.

As illustrated, a user may park their EV adjacent to one of the charging pillar 126 and connect the EV to the charging pillar 126 using the charging cable 140. The charging cable 140 may be provided by the charging pillar 126, may be stored at the charging facility, or may be carried by the user in their EV. When the user is parked adjacent to the charging pillar 126, the ROS 102 may not be located near the charging pillar 126 but may instead be more distantly located. As discussed above, after connecting their EV to the charging pillar 126, the user may use a mobile device to activate the charging pillar 126. When the charging pillar 126 is activated, a ROS 102 may be deployed from a charge hub 124 to the charging pillar 126. When deployed, the ROS 102 may autonomously position itself to connect to the connection interface 136 on the charging pillar 126 and deliver energy from the battery 116 to the charging pillar 126, which then delivers the energy to the EV through the charging cable 140.

As illustrated in FIG. 5b, the receptacle 138 where the charging cable 140 connects to the charging pillar 126 is positioned significantly higher than the connection interface 136 and is also provided at a position perpendicular to the connection interface 136. This configuration may allow the charging cable 140 to remain clear of the zone into which the ROS 102 will need to move to connect to the connection interface 136. This can prevent the ROS 102 from becoming entangled and/or trapped by the charging cable 140 or the charging cable 140 impeding access by the ROS 102 to the connection interface 136.

In some embodiments, instead of a connection interface 136, a battery interface may be provided. Instead of having the ROS 102 connecting itself to the connection interface 136 or the battery interface, the ROS 102 simply acts as a transporter for delivering or retrieving battery modules or battery packs for direct interfacing. When deployed, the ROS 102 may autonomously position itself to connect or disconnect the battery modules or battery packs on the charging pillar 126 through the battery interface. When the action is one that relates to EV charging, then energy is delivered from the battery modules or battery packs to the charging pillar 126, which then delivers the energy to the EV through the charging cable 140. When the action is one that relates to battery retrieval, where charging is completed, then the ROS 102 disconnects the battery modules or battery packs from the charging pillar 126 and proceeds to the next charging pillar 126 for EV charging or to the charge hub 124 for battery charging.

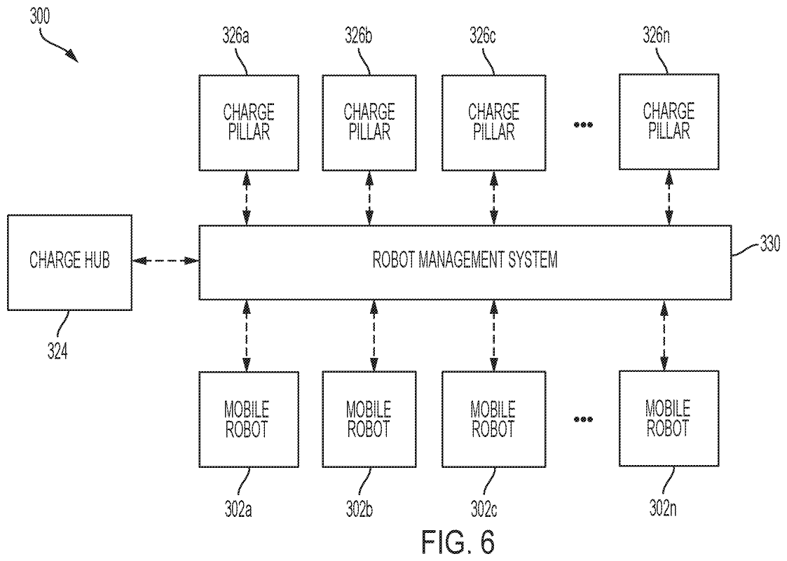

FIG. 6 is a block diagram illustrating a non-limiting example of a system 300, according to some embodiments.

The system 300 may be part of a charging facility capable of charging a plurality of EV vehicles simultaneously. The system 300 includes charge hub 324 at a first location in electrical connection with the grid power source or other power generator source. The charge hub 324 is configured to electrically connect with ROS 302 to charge the battery in the ROS 302, such as battery 116 in ROS 102.

The system 300 includes a plurality of charging pillars 326. Referring to FIG. 6, system 300 includes charging pillar 326a, 326b, 326c, 326n, hereinafter referred to as charging pillars 326. The charging pillars 326 are located at a second location remote from the first location. Additionally, each charging pillar 326 may be at a distinct location at the second location, e.g., at each parking space.

The system 300 includes a plurality of ROS 102. Referring to FIG. 6, the system 300 includes ROS 302a, 302b, 302c, 302n, hereinafter referred to as ROS 302. The system 300 also includes robot management system 330 in electrically communicable connection with the charge hub 324, the charging pillars 326, and each ROS 302. The robot management system 330 can monitor a status of charge hub 324, charging pillars 326, and each ROS 302. Additionally, when a request to charge an EV battery is obtained from one of the charging pillars 326, the robot management system 330 can identify a location of the charging pillar 326 in the second location, identify an available ROS 302 having an adequate charge level, map a course navigating the ROS 302 from the current location (e.g., charge hub 324), and send a command deploying the ROS 302 to the charging pillar 326 to fulfill the charge request. In some embodiments, the robot management system 330 may be stored in a computing device of the charging facility. In other embodiments, the ROS 302 may be stored in the computing device of the ROS 302 and in electrically communicable connection with each of the other ROS 302 in the network of system 300.

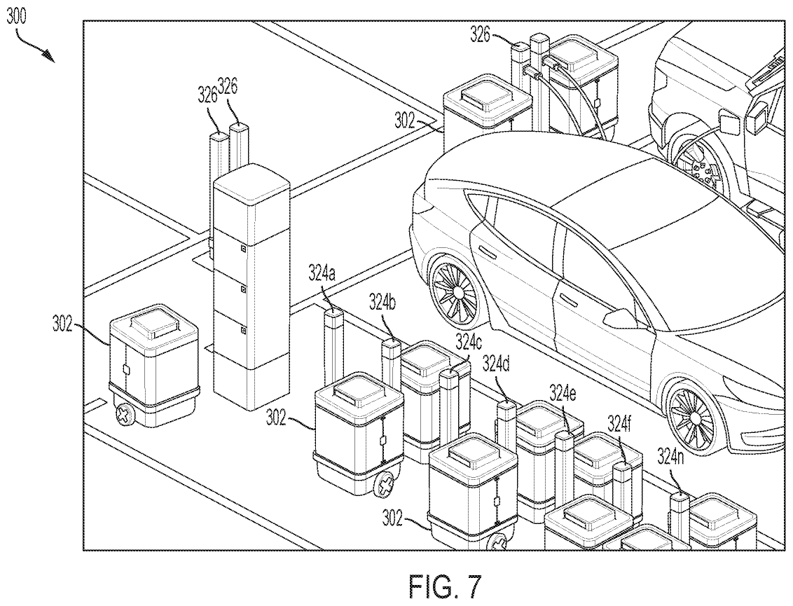

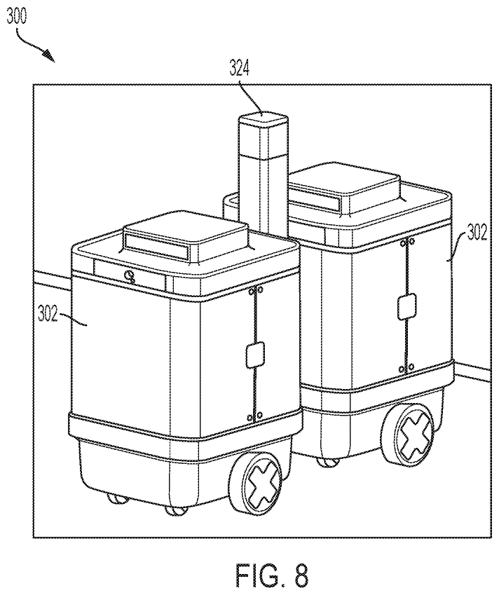

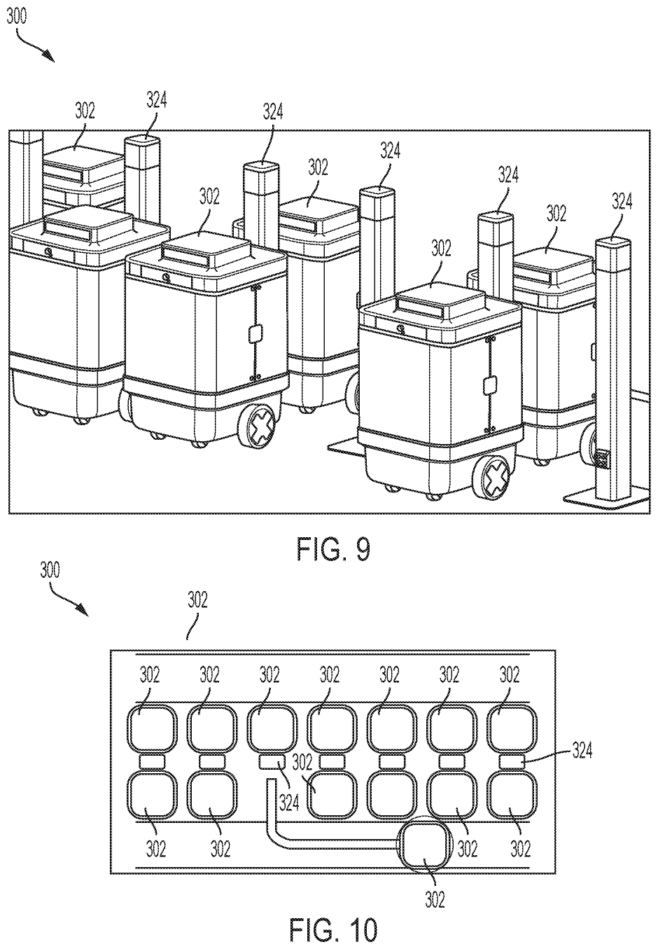

FIG. 7 is a perspective view of the system 300, according to some embodiments. FIG. 8 is a perspective view illustrating a portion of system 300, according to some embodiments. FIG. 9 is a perspective view illustrating a non-limiting example of system 300, according to some embodiments. FIG. 10 is graphical illustrations of a portion of system 300, according to some embodiments. Unless specifically referenced, FIGS. 7-10 will be described collectively.

In some embodiments, the system 300 includes one or more charging hubs 324. The charge hub 324 may be designed with a modular design that enables multiple charging hubs 324 to be located in a designated area to allow charging of multiple ROS 102 simultaneously. Further, each charge hub 324 may also include lighting beacons at the top of the charge hub 324 to increase visibility in a parking lot as well as provide indications of status of the charge hub 324 or the connected ROS 302. For example, the lighting beacons may signal that robots are in a charging state or in a ready state depending on color or pattern of lighting displayed.

Referring to FIG. 7, the system 300 includes charging hubs 324a, 324b, 324c, 324d, 324e, 324f, through 324n for connecting to the ROS 302 and simultaneously charging the ROS 302. In some embodiments, each charge hub 324 includes one of the connection interface 336 and may be capable of electrically connected to and charging one ROS 302 at a time.

Referring to FIG. 8, in some embodiments, each charge hub 324 may include two of the connection interface, such as connection interface 136 in FIG. 5b, and may be capable of electrically connecting to and charging two ROS 302 at one time. In some embodiments, the connection interfaces 336 may be located on opposite sides of the charge hub 324 and the ROS 302 may connect to the ROS 302 at each of the sides having the connection interface 336. In other embodiments, the connection interfaces 136 may be located on adjacent sides of charge hub 324.

Referring to FIG. 9, multiple charge hub 324 may be placed in a line at one end of a parking area adjacent to the robot run. This would allow multiple ROS 302 to be charged and deployed to the EV charging pillars via the robot run based on commands sent from the robot management system 330. Once the ROS 302 has completed charging the EV battery (e.g., when the battery 116 is depleted or near depletion), the robot management system 330 and/or the ROS 302 may navigate back to the charge hub 324 to charge the battery 116. In this regard, the robot management system 330 determines one of the charge hub 324 available to charge the ROS 302. In some embodiments, the robot management system 330 may determine an available connection interface 336 on the charge hub 324 to charge the ROS 302. Additionally, the mapping to return the ROS 302 to the charge hub 324 may include instructions directing the ROS 302 to the particular charge hub 324 and the available connection interface 336.

In some embodiments, a parking space located within a row of parking spaces may be designated as the charging hub 324 placement location and multiple charge hub 324 may be placed within the parking space. The relatively small size of the charge hub 324 and the ROS 302 may allow multiple charging hubs 324, each capable of charging two ROS 302, may be placed in a single packing space.

The ROS 302 may be designed with the drive wheels 332 being independently driven, and centrally located between one or more caster wheels, the ROS 302 may be provided with a small turning radius that allows the ROS 302 to maneuver into charging positions easily even if the charge hub 324 are tightly packed into a small area, like a single parking space.

Referring to FIG. 10, the charge hub 324 includes a plurality of charging hubs 324. Once the ROS 302 has completed charging the EV battery, the ROS 302 returns to the plurality of charging hubs 324 and navigates to an available charge hub 324 and connects to the available charge hub 324 to charge the battery 116.

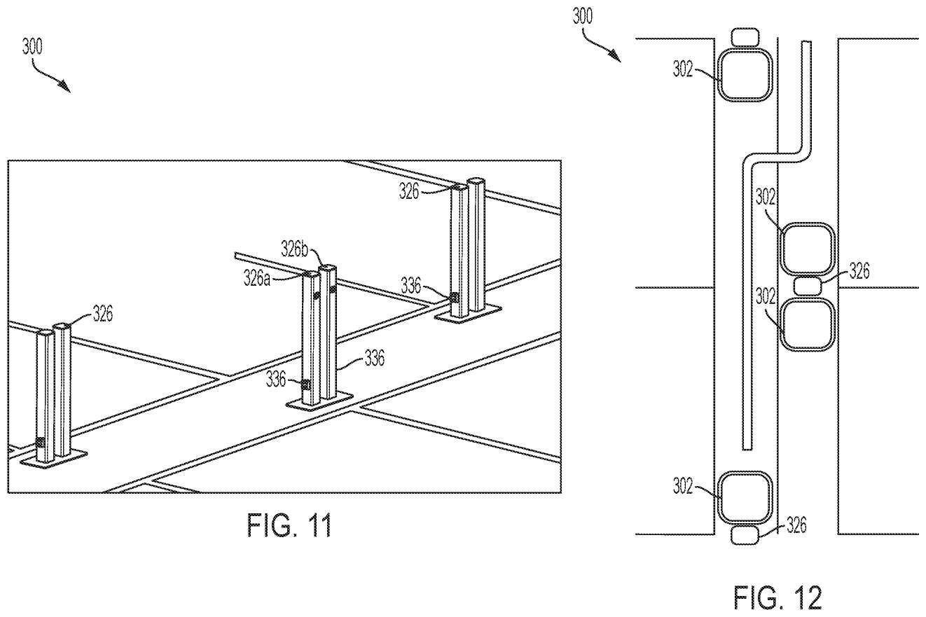

FIG. 11 is a perspective view illustrating a non-limiting example of a portion of system 300, according to some embodiments. FIG. 12 is a graphical illustration of the portion of system 300, according to some embodiments. Unless specifically referenced, FIGS. 11 and 12 will be described collectively.

The system 300 includes one or more charging pillars 326. Each charging pillar 326 may be located at a charging location for the EV (e.g., parking space) in the charging facility. The charging pillar 326 may include charging pillar 326a, 326b paired adjacent each other between two charging locations (e.g., parking spaces), with the connection interface 336 for each of the charging pillar 326 located opposite the other charging pillar 326, to enable the ROS 302 to connect to one of the two charging pillar 326 to charge an EV parked at each respective charging location.

The charging pillars 326 may be deployed in a double pillar configuration with each pair of pillars positioned at one end of a pair of adjacent parking spaces. The pillars may be placed in designated non-parking area between rows of parking spaces. The non-parking area may be designated as a robot run area for ROS 302 to travel without impeding traffic moving within the parking area.

Each pair of charging pillars 326 may be offset in an alternating manner to be positioned adjacent to parking spaces on both sides of the robot run area. If the robot run area has a width of at least 1400 mm (double the width of the robot form factor), this alternating arrangement of the pairs of charging pillars may provide two lanes of travel for robots to maneuver around one another and travel up and down the robot run. The robot run area may thus allow the ROS 302 to conveniently travel from the charging pillar 326 to the charge hub 324.

According to some embodiments, the ROS 302 includes a connector and docking port, such as connector 114 and the docking port 168 of ROS 102 of FIG. 1, that directly connects to the charging hub 324 to charge the battery and the charging pillar 326 to charge the EV battery with the battery. In some embodiments, the ROS 302 and the connector and the docking port do not directly connect to the EV and/or the EV battery. Instead, to charge the EV battery, the ROS 302 connects to the charging pillar 326 and the charging pillar 326 connects to the EV to charge the EV battery with the electrical energy stored in the battery 116 of the ROS 302.

Referring to FIG. 12, in response to the request to charge the EV battery at one of the charging pillar 126 in the charging facility, the robot management system 130 may map the course for the ROS 102 to navigate from the charge hub 124 to the charging pillar 126 and send the mapping to the ROS 102. The ROS 102 may obtain the mapping and navigate to the charging pillar 126 associated with the request to charge the EV battery, as shown in FIG. 12.

By using systems in accordance with embodiments of the present application, EV charging capabilities may be deployed to a number of parking spaces along a row of spaces in an existing parking structure. The flexible EV charging deployment removes the need to have wire charging infrastructure for every parking space. For example, power charging connections (e.g., connections to a power grid or power generation system) may be wired to a single parking space, in which a charging hub 324 with multiple pillars has been placed. Similarly, a plurality of charging pillar 326 may be deployed along a row of parking spaces with a robot run extending along the line of parking spaces. Each of the deployed charging pillar 326 would not require being wired to the power grid or power generation systems as the power would be supplied to each charging pillar 326 dynamically using the ROS 302.

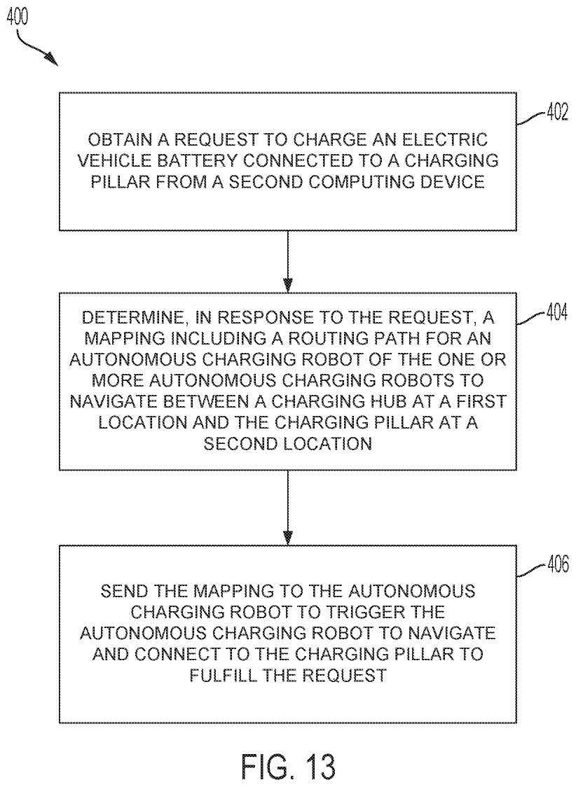

FIG. 13 is a flow diagram illustrating a method 400, according to some embodiment.

At 402, the method 400 includes obtaining, by a computing device, a request to charge an electric vehicle battery connected to a charging pillar 126 for a charging station from a second computing device. The charging pillar 126 may be located at a location remote from a location of a charging hub 124 that is connected to the power source (e.g., grid power source, solar array, electric generators, etc.). The charging pillar 126 may be connected to the EV through a charging cable 140 connected to a receptacle 138 located on the charging pillar 126. In some embodiments, obtaining the request to charge the EV battery may include obtaining an electric signal from the charging pillar 126 corresponding to the charging pillar 126 being electrically and mechanically connected to the EV. In some embodiments, the charging pillar 126 may include one or more electronic sensors to detect the charging pillar 126 is electronically connected to the EV. In other embodiments, the charging pillar 126 may include one or more mechanical sensors or interlocks to detect the charging pillar 126 is electronically connected to the EV. In some embodiments, the charging pillar 126 may include one or more sensors to detect the charging cable 140 is mechanically connected to the charging pillar 126 and may include one or more current sensors to detect the charging pillar 126 is electronically connected with the EV battery through the charging cable 140. In some embodiments, the charging cable 140 may include the one or more sensors and the charging pillar 126 may be in electrically communicable connection with the charging cable 140 to obtain electronic signals from the one or more sensors.

At 404, the method 400 includes determining, in response to the request, a mapping including a routing path for an autonomous charging robot of one or more autonomous charging robots to navigate between a charging hub 124 at a first location and the charging pillar 126 at a second location to enable the autonomous charging robot to move from its current location and to the charging pillar 126 to fulfill the charge request. The autonomous charging robot may be the ROS 102 (as shown in FIGS. 1-3), according to some embodiments. The mapping may include an area of the charging facility including the charging hub 124 at the first location and the charging pillar 126 at the second location. In some embodiments, the mapping may include the routing path from the autonomous charging robot's current location to the charging pillar 126 and back to the charge hub 124.

The request to charge the EV battery may be fulfilled based on the availability of each autonomous charging robot of the one or more autonomous charging robots. In this regard, the autonomous charging robot may be selected based on one or more operating parameters of the robot, an availability of the robot, the amount of charge level stored in the battery 116 of the robot, a number of charge operations performed using the particular battery 116 in the robot (e.g., load balancing to reduce wear on the robot and the battery 116), other factors, or any combinations thereof.

At 406, the method 400 includes sending the mapping to the autonomous charging robot to trigger the autonomous charging robot to navigate and connect to the charging pillar 126 to fulfill the request. Once the mapping is obtained by a computing device of the autonomous charging robot, the robot moves from the charge hub 124 or its current location to the charging pillar 126 to charge the EV battery.

In some embodiments, the method 400 may include determining the electric vehicle is electrically connected to the charging pillar 126. The method 400 may also include determining the autonomous charging robot is electrically connected to the charging pillar 126, and controlling the charging pillar 126 to enable a battery 116 of the autonomous charging robot to charge the electric vehicle battery. In some embodiments, the autonomous charging robot may provide an electronic signal to the computing device indicative that the autonomous charging robot is connected to the charging pillar 126. In some embodiments, the charging pillar 126 may provide an electronic signal to the computing device indicative that the autonomous charging robot is connected to the charging pillar 126. In other embodiments, the computing device may wait to charge the EV battery until the signal is obtained from both the autonomous charging robot and the charging pillar 126.

Once the autonomous charging robot reaches the charging pillar 126, the autonomous charging robot is configured to electrically connect with the connection interface 136 on the charging pillar 126 to charge the electric vehicle battery. In some embodiments, the computing device may be in electronically communicable connection with the computing device of the autonomous charging robot to coordinate deployment of the autonomous charging robot to fulfill the request. In other embodiments, the computing device may include the computing device of the autonomous charging robot. Each computing device of the one or more autonomous charging robots may be connected to each other over a network to coordinate deployment of the autonomous charging robots to fulfill requests to charge EV batteries.

In some embodiments, the method 400 includes determining routing paths of other autonomous charging robots and predicting a position of the other autonomous charging robots during navigation of the autonomous charging robot to the charging pillar 126. In order to reduce a likelihood of collisions between the autonomous charging robots in the charging facility, the mapping and the routing path of the autonomous charging robot may be determined based on the routing paths and predicted positions of the other autonomous charging robots in the charging facility when the autonomous charging robot moves through the charging facility to fulfill the request.

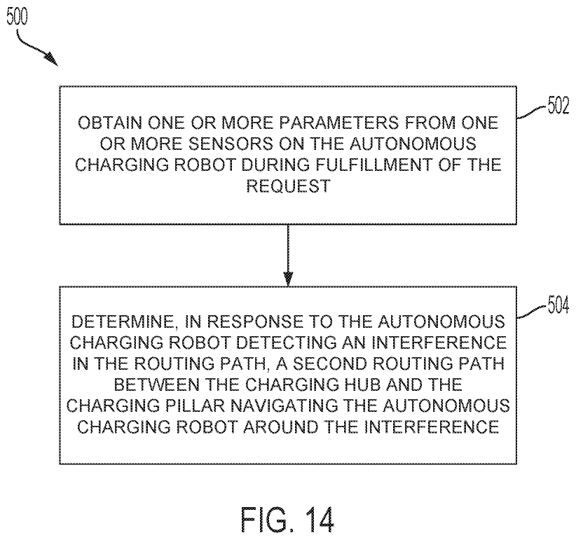

FIG. 14 is a flow diagram illustrating a method 500, according to some embodiment.

At 502, the method 500 includes obtaining one or more parameters from one or more sensors on the autonomous charging robot during fulfillment of a request to charge an EV battery. In some embodiments, the one or more sensors may be selected from a group comprising light detection and ranging sensors, cameras, gyroscopes, global positioning system (GPS), battery charge level detectors, and current and voltage detectors. In other embodiments, the one or more sensors may be selected from a group consisting of light detection and ranging sensors, cameras, gyroscopes, global positioning system (GPS), battery charge level detectors, and current and voltage detectors.

At 504, the method 500 includes determining, in response to the autonomous charging robot detecting an interference in the routing path, a second routing path between the charging hub 124 and the charging pillar 126 navigating the autonomous charging robot around the interference. The second routing path may be a new route between the charging hub 124 and the charging pillar 126 based on a current location and position of the autonomous charging robot in the mapping. As the autonomous charging robot moves along the routing path to connect to the charging pillar 126 to charge the EV battery or to connect to the charge hub 124 to charge the battery 116, an obstruction or interfering object may be detected by the one or more sensors on the autonomous charging robot. For example, the autonomous charging robot may include the vision component 112 for performing light detection and ranging processes and/or techniques to detect for objects in an area surrounding the autonomous charging robot. In response to detecting objects in the area of the autonomous charging robot including the interfering object in the path of the routing path, the autonomous charging robot may determine a second routing path which enables the autonomous charging robot to avoid the interfering object or objects and return to the first routing path, according to some embodiments. In other embodiments, the autonomous charging robot may send the measured sensor data to the computing device of the robot management system 130, and the robot management system 130 may determine the second routing path to the charging pillar 126 to fulfill the request.

In some embodiments, the charging facility may include a plurality of charging hubs 124 at the first location and a plurality of charging pillars 126 at the second location such as shown in FIG. 6. This enables the charging facility to charge a plurality of EVs simultaneously to improve the overall efficiency of the charging facility and to improve the number of EVs that may be charged at a time to reduce excessive wait times for customers. In some embodiments, each charging pillar 126 may be located at a parking space at the charging facility. Accordingly, the mapping sent to the autonomous charging robot may navigate the autonomous charging robot to the charging pillar of the plurality of charging pillars in the specific location associated with the request. In some embodiments, the request may include one or more identifiers for the particular charging pillar 126 of the plurality of charging pillar 126 and the mapping may be determined based on the exact location of the charging pillar 126 at the second location.

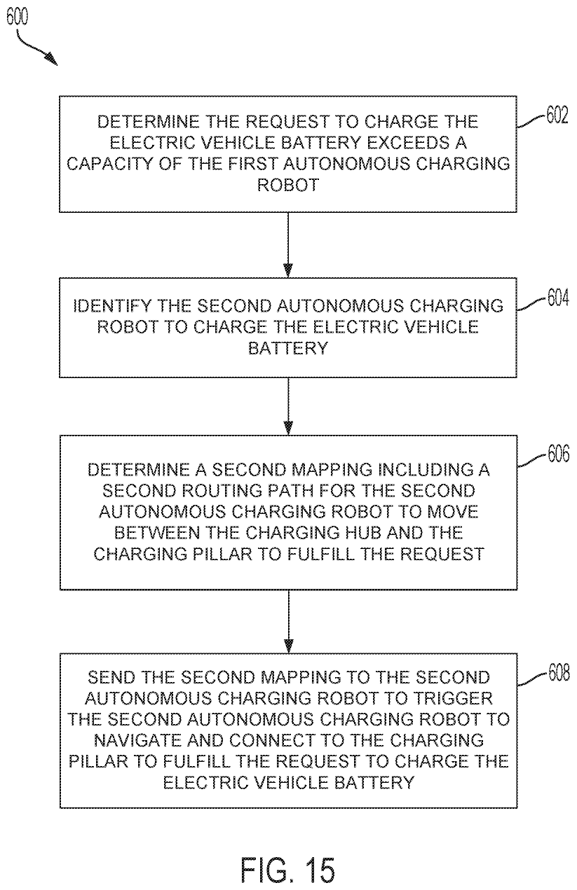

FIG. 15 is a flow diagram illustrating a method 600, according to some embodiment.

The charging facility may include a plurality of the autonomous charging robots such as shown in FIG. 6. The plurality of autonomous charging robots may include, at least, a first autonomous charging robot and a second autonomous charging robot. At 602, the method 600 includes determining the request to charge the electric vehicle battery exceeds a capacity of the first autonomous charging robot. In some embodiments, the EV battery capacity may exceed the capacity of the battery 116 in one of the autonomous charging robot and the EV may need a full charge to go from the charging facility to its destination. Accordingly, the EV battery may need to be charged with more than one of the autonomous charging robots.

At 604, the method 600 includes identifying the second autonomous charging robot to charge the electric vehicle battery. The first and second autonomous charging robots may be connected to the charge hub 124. In some embodiments, one of the first and second autonomous charging robots may be connected to the charge hub 124 and the other of the first and second autonomous charging robots may be at a different location such as, for example, completing a charge request at a different charging pillar 126. In order to improve efficiency in fulfilling the requests to charge the EV battery, if the other of the first and second autonomous charging robots includes a charge level remaining in the battery 116, it may also be sent to the charging pillar 126 to fulfill the charge requests.

At 606, the method 600 includes determining a second mapping including a second routing path for the second autonomous charging robot to move between the charging hub 124 and the charging pillar 126 to fulfill the request. At 608, the method 600 includes sending the second mapping to the second autonomous charging robot to trigger the second autonomous charging robot to navigate and connect to the charging pillar 126 to fulfill the request to charge the electric vehicle battery. In some embodiments, the mapping to the first autonomous charging robot may correspond to a first charge period and the second mapping to the second autonomous charging robot may correspond to a second charge period. In some embodiments, the second charge period occurs after the first charge period and fulfilling the request comprises the first charge period and the second charge period.

The charging pillar 126 may further include a first connection interface 136 on a first side of the charging pillar 126 and a second connection interface 136 on a second side of the charging pillar 126. One of the first autonomous charging robot and the second autonomous charging robot may connect to the first connection interface and the other of the first autonomous charging robot and second autonomous charging robot may connect to the second connection interface to charge the EV battery, according to some embodiments. Additionally, in some embodiments, the charging pillar 126 may charge the EV battery with the first autonomous charging robot and the second autonomous charging robot simultaneously. In other embodiments, the charging pillar 126 may charge the EV battery with one of the first autonomous charging robot and second autonomous charging robot during a first charge period and the other of the first autonomous charging robot and second autonomous charging robot during a second charge period.

This may be repeated using one or more other ones of the autonomous charging robots until the charge request is completed. It is to be appreciated by those having ordinary skill in the art that the EV battery may be charged with one or more of the autonomous charging robot such as, for example, the ROS 102 shown in FIGS. 1 and 6, until the request is complete, in accordance with the present disclosure.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein “embedded” means that a first material is distributed throughout a second material.

What is claimed is:

1. A system for charging an electric vehicle including one or more autonomous charging robots, the system comprising:
a computing device comprising:
a processor, and
a non-transitory computer readable medium having stored thereon instructions that are executable by the processor to enable the system to perform operations comprising:
obtain a request to charge an electric vehicle battery connected to a charging pillar from a second computing device,
determine, in response to the request, a mapping including a routing path for an autonomous charging robot of the one or more autonomous charging robots to navigate between a charging hub at a first location and the charging pillar at a second location, and
send the mapping to the autonomous charging robot to trigger the autonomous charging robot to navigate and connect to the charging pillar to fulfill the request; and
wherein the autonomous charging robot is configured to electrically connect with the charging pillar to charge the electric vehicle battery;
wherein the computing device is in electronically communicable connection with the autonomous charging robot to coordinate deployment of the autonomous charging robot to fulfill the request.

2. The system of claim 1, wherein the mapping further comprises an area including the charging hub at the first location and the charging pillar at the second location.

3. The system of claim 2, wherein the system further performs operations comprising:
determine routing paths of other autonomous charging robots and predict a position of the other autonomous charging robots during navigation of the autonomous charging robot to the charging pillar,
wherein the routing path of the autonomous charging robot between the charging hub and the charging pillar is determined based on routing paths of the other autonomous charging robots and their predicted positions.

4. The system of claim 1, wherein the system further performs operations comprising:
obtain one or more parameters from one or more sensors on the autonomous charging robot during fulfillment of the request, and
determine, in response to the autonomous charging robot detecting an interference in the routing path, a second routing path between the charging hub and the charging pillar navigating the autonomous charging robot around the interference,
wherein the second routing path comprises a new route between the charging hub and the charging pillar based on a current location and position of the autonomous charging robot in the mapping.

5. The system of claim 4, wherein the one or more sensors is selected from a group comprising light detection and ranging sensors, cameras, gyroscopes, global positioning system (GPS), battery charge level detectors, and current and voltage detectors.

6. The system of claim 1, wherein the system further comprises:
a plurality of charging hubs at the first location, and
a plurality of charging pillars at the second location; and
wherein the mapping navigates the autonomous charging robot to the charging pillar of the plurality of charging pillars;
wherein each charging location in a charging facility comprises one of the plurality of charging pillars.

7. The system of claim 1, wherein the one or more autonomous charging robots comprises a first autonomous charging robot and a second autonomous charging robot.

8. The system of claim 7, wherein the system further performs operations comprising:
determine the request to charge the electric vehicle battery exceeds a capacity of the first autonomous charging robot,
identify the second autonomous charging robot to charge the electric vehicle battery,
determine a second mapping including a second routing path for the second autonomous charging robot to move between the charging hub and the charging pillar to fulfill the request, and
send the second mapping to the second autonomous charging robot to trigger the second autonomous charging robot to navigate and connect to the charging pillar to fulfill the request to charge the electric vehicle battery.

9. The system of claim 8, wherein the mapping to the first autonomous charging robot corresponds to a first charge period and the second mapping to the second autonomous charging robot corresponds to a second charge period, wherein the second charge period occurs after the first charge period and fulfilling the request comprises the first charge period and the second charge period.

10. The system of claim 7, wherein the charging pillar comprises:
a first connection interface on a first side of the charging pillar, and
a second connection interface on a second side of the charging pillar,
wherein the first autonomous charging robot connects to the first connection interface or the second connection interface and the second autonomous charging robot connects to the other of the first connection interface and the second connection interface.

11. The system of claim 1, wherein the system further performs operations comprising:
determine the electric vehicle is electrically connected to the charging pillar,
determine the autonomous charging robot is electrically connected to the charging pillar, and
control the charging pillar to enable a battery of the autonomous charging robot to charge the electric vehicle battery.

12. A computer-implemented method comprising:
determining an electric vehicle is electrically connected to a charging pillar;
determining, by a computing device and in response to a request to charge an electric vehicle battery connected to the charging pillar, a mapping including an area of a charging hub and the charging pillar and including a routing path for an autonomous charging robot to navigate between the charging hub at a first location and the charging pillar at a second location;
determining, by the computing device, routing paths of other autonomous charging robots and predict a position of the other autonomous charging robots during navigation of the autonomous charging robot to the charging pillar;
sending, by the computing device, the mapping to the autonomous charging robot to trigger the autonomous charging robot to navigate and connect to the charging pillar to fulfill the request,
obtaining, by the computing device, one or more parameters from one or more sensors on the autonomous charging robot during fulfillment of the request;
control the charging pillar to enable a battery of the autonomous charging robot to charge the electric vehicle battery; and
wherein the autonomous charging robot is configured to electrically connect with the charging pillar to charge the electric vehicle battery;
wherein the computing device is in electronically communicable connection with the autonomous charging robot to coordinate deployment of the autonomous charging robot to fulfill requests to charge electric vehicle batteries.

13. The computer-implemented method of claim 12, further comprising:
obtaining one or more parameters from one or more sensors on the autonomous charging robot during fulfillment of the request, and
determining, in response to the autonomous charging robot detecting an interference in the routing path, a second routing path between the charging hub and the charging pillar navigating the autonomous charging robot around the interference;
wherein the second routing path comprises a new route between the charging hub and the charging pillar based on a current location and position of the autonomous charging robot in the mapping.

14. The computer-implemented method of claim 12, wherein the autonomous charging robot comprises a first autonomous charging robot and a second autonomous charging robot.

15. The computer-implemented method of claim 14, further comprising:
determining the request to charge the electric vehicle battery exceeds a capacity of the first autonomous charging robot,
identifying the second autonomous charging robot to charge the electric vehicle battery,
determining a second mapping including a second routing path for the second autonomous charging robot to move between the charging hub and the charging pillar to fulfill the request,
sending the second mapping to the second autonomous charging robot to trigger the second autonomous charging robot to navigate and connect to the charging pillar to fulfill the request, and
wherein the mapping to the first autonomous charging robot corresponds to a first charge period and the second mapping to the second autonomous charging robot corresponds to a second charge period,
wherein the second charge period occurs after the first charge period and fulfilling the request comprises the first charge period and the second charge period.

16. The computer-implemented method of claim 15, wherein the charging pillar comprises:
a first connection interface on a first side of the charging pillar, and
a second connection interface on a second side of the charging pillar,
wherein the first autonomous charging robot connects to the first connection interface or the second connection interface and the second autonomous charging robot connects to the other of the first connection interface and the second connection interface.

17. A computer program product comprising instructions stored on a non-transitory computer readable medium of a computing device, the instructions being executable by a processor to enable the computing device to perform operations comprising:
determine an electric vehicle is electrically connected to a charging pillar;
determine, in response to a request to charge an electric vehicle battery connected to the charging pillar, a mapping including an area of a charging hub and the charging pillar and including a routing path for an autonomous charging robot to navigate between the charging hub at a first location and the charging pillar at a second location of a charging facility;
determine routing paths of other autonomous charging robots and predict a position of the other autonomous charging robots in the charging facility during navigation of the autonomous charging robot to the charging pillar;
send the mapping to the autonomous charging robot to trigger the autonomous charging robot to navigate and connect to the charging pillar to fulfill the request, obtain one or more parameters from one or more sensors on the autonomous charging robot during fulfillment of the request;
control the charging pillar to enable a battery of the autonomous charging robot to charge the electric vehicle battery; and
wherein the autonomous charging robot is configured to electrically connect with the charging pillar to charge the electric vehicle battery;
wherein the computing device is in electronically communicable connection with the autonomous charging robot to coordinate deployment of the autonomous charging robot to fulfill the request.

18. The computer program product of claim 17, further performing operations comprising:
obtain one or more parameters from one or more sensors on the autonomous charging robot during fulfillment of the request, and
determine, in response to the autonomous charging robot detecting an interference in the routing path, a second routing path between the charging hub and the charging pillar navigating the autonomous charging robot around the interference;
wherein the second routing path comprises a new route between the charging hub and the charging pillar based on a current location and position of the autonomous charging robot in the mapping.

19. The computer program product of claim 17, further performing operations comprising:
determine the request to charge the electric vehicle battery exceeds a capacity of the autonomous charging robot,
identify a second autonomous charging robot to charge the electric vehicle battery,
determine a second mapping including a second routing path for the second autonomous charging robot to move between the charging hub and the charging pillar to fulfill the request,
send the second mapping to the second autonomous charging robot to trigger the second autonomous charging robot to navigate and connect to the charging pillar to fulfill the request, and
wherein the mapping to the autonomous charging robot corresponds to a first charge period and the second mapping to the second autonomous charging robot corresponds to a second charge period,
wherein the second charge period occurs after the first charge period and fulfilling the request comprises the first charge period and the second charge period.

20. The computer program product of claim 19, wherein the charging pillar comprises:
a first connection interface on a first side of the charging pillar, and
a second connection interface on a second side of the charging pillar,
wherein the autonomous charging robot connects to the first connection interface or the second connection interface and the second autonomous charging robot connects to the other of the first connection interface and the second connection interface to simultaneously charge the electric vehicle battery.
